(19) United States
(12) Patent Application Publication
(10) Pub. No.: US 2026/0131574 A1
(43) Pub. Date: May 14, 2026

(54) CONTAINERS WITH ISOLATING VENT PATHS

(71) Applicant: Hewlett-Packard Development Company, L.P., Spring, TX (US)

(72) Inventors: Kundan Singh, Singapore (SG); Paul Mark Haines, Corvallis, OR (US); Zachary Hein, Vancouver, WA (US); Jeffrey Wagner, Vancouver, WA (US); Sean Bertles, Corvallis, OR (US)

(21) Appl. No.: 19/121,533

(22) PCT Filed: Oct. 17, 2022
(86) PCT No.: PCT/US2022/046863

§ 371 Date: Apr. 16, 2025

(51) Int. Cl. B41J 2/175

(52) U.S. Cl. CPC B41J 2/17556; B41J 2/1754; B41J 2/17553

(57) ABSTRACT

An example apparatus may comprise an opening to allow air to pass in and out of the apparatus, a barrier film covering the opening to prevent print substance from exiting the apparatus, an isolation region to house a print substance, and a plurality of vent paths to allow air to vent from the opening when the apparatus is in different orientations.

### BACKGROUND

Imaging systems, such as printers, copiers, etc., may generate text, images, or objects on print media (e.g., paper, plastic, a bed of build material in the case of Three-Dimensional (3D) printing, etc.). In some examples, imaging systems may perform a print job comprising printing text and/or graphics by transferring print substance (e.g., ink, toner, binding agent, etc.) to print media.

### BRIEF DESCRIPTION OF THE DRAWINGS

FIG. 1 illustrates an example apparatus including a print substance container.

FIG. 2 illustrates an example system including a print substance container.

FIG. 3A illustrates an example print substance container in a particular orientation.

FIG. 3B illustrates an example print substance container in a particular orientation.

FIG. 3C illustrates an example print substance container in a particular orientation.

FIG. 3D illustrates an example print substance container in a particular orientation.

FIG. 3E illustrates an example print substance container in a particular orientation.

### DETAILED DESCRIPTION

Print substance containers, apparatuses, and systems are described herein. In some examples, print substance containers may house print substance for use in a variety of imaging systems, such as printers, etc., for example. In some examples, the print substance container may contain openings to allow air to vent from the print substance container.

However, some print substance containers include one path to vent air from the print substance container. Print substance containers that include a limited number of paths to vent air from the container may not have an alternative avenue for venting air when the path is blocked. As such, negative pressure and/or positive pressure may build in the container and cause print substance to leak from the container. Further, some print substance containers increase the volume of the print substance container to absorb overflow print substance. However, increasing the volume of the print substance containers can increase the price of making the container, increase the material used to create the container, and may still be subject to leakages due to negative pressure and/or positive pressure, if the venting path is blocked.

However, print substance containers as described herein are compact and prevent leakage by including a plurality of vent paths to ensure that air is able to vent from the print substance container. For example, the print substance container may include an opening to allow air to pass in and out of the print substance container. In some examples, a barrier film may cover the opening to prevent print substance from exiting the print substance container via the opening. The isolation region of the print substance container may house the print substance while in the print substance container. The print substance container can include a plurality of vent paths to allow air within the print substance container to vent from the openings when the print substance container is in different orientations.

If air is not properly vented from the container, negative pressure and/or positive pressure can build in the container. A build-up of negative pressure and/or positive pressure can cause print substance to leak from the container. Accordingly, this detailed description describes print substance containers that include a plurality of vent paths to allow air to vent from the print substance container when the orientation of the print substance container changes.

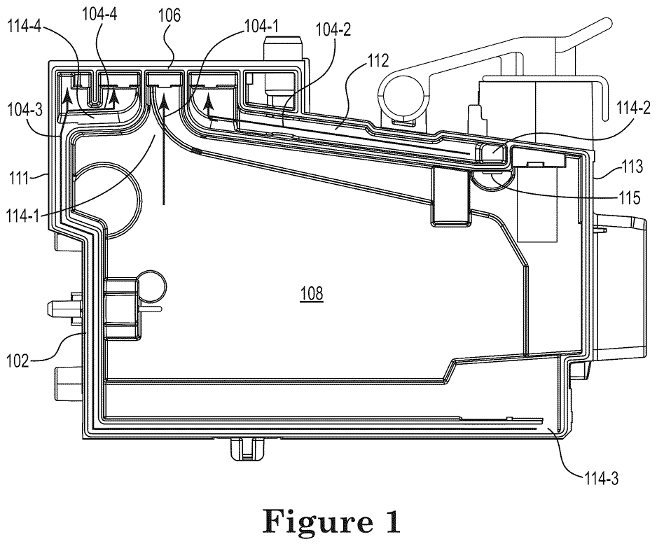

FIG. 1 illustrates an example apparatus including a print substance container 102. The apparatus may be implemented in a variety of imaging systems, such as printers, copiers, etc., for example. In some examples, the print substance container 102 includes an isolation region 108 to house print substance. The isolation region 108 in conjunction with other elements of the print substance container 102 ensures that print substance remains in the print substance container 102 when the print substance container 102 is moved (e.g., the orientation of the print substance container changes). For instance, the apparatus includes a plurality of vent paths 104-1, 104-2, 104-3, 104-4 (vent paths 104-1, 104-2, 104-3, 104-4 can collectively be referred to as vent paths 104) to allow air to leave the print substance container 102 and causes the print substance to be contained in a particular area (e.g., isolation region 108) of the print substance container 102. For example, the apparatus can include a primary vent path 104-1, a secondary vent path 104-2, and a tertiary vent path 104-3, 104-4. As used herein, “vent path” refers to a route, course, or track along which air, gas, and/or liquid moves.

In some examples, the plurality of vent paths allow air to vent from an opening when the print substance container 102 is in different orientations. That is, the plurality of vent paths 104 prevent print substance from leaking from the print substance container 102 when the orientation of the print substance container 102 shifts by allowing air to vent from the print substance container 102. Said differently, the plurality of vent paths 104 confine print substance into the isolation region 108. As used herein, “print substance container” refers to a vessel, bottle, bag, box, carton, enclosure, or other suitable receptacle for the transfer and/or containment of a print substance. As used herein, “confine” refers to the act of keeping or restricting something within certain limits of space.

In some examples, using a plurality of vent paths 104 ensures that air is able to vent through the opening 106 even if another vent path 104 is blocked. As such, print substance will remain in the print substance container 102 as air is venting through one vent path, while the other vent paths are blocked. As used herein, “print substance” refers to ink, toner, binding agent, etc. used to print text and/or graphics on print media. As used herein, “print media” refers to a plurality of papers, photopolymers, plastics, composites, metals, woods, or other material on which markings may be formed.

In some examples, air enters though primary entrance 114-1, secondary entrance 114-2, and tertiary entrance 114-3 (entrances 114-1, 114-2, 114-3 can collectively be referred to as entrances 114) to flow through the vent paths 104. In some examples, the entrances 114 can be unobstructed. That is, there may not be an obstruction limiting access to the vent pathways 104. However, this disclosure is not so limited. In some examples, there may be an obstruction 115 blocking the path to the vent pathways 104. The obstruction 115 may limit what can enter the vent pathways 104. For example, secondary entrance 114-2 has an obstruction 115 blocking the secondary entrance 114-2. The obstruction 115 limits the amount of material that enters through the secondary entrance 114-2. The obstruction 115 may allow air to pass through the secondary entrance 114-2 but may not let print substance enter. The air in the print substance container 102 can vent through the opening 106. That is, each vent path 104-1, 104-2, 104-3, 104-4 leads to the opening 106. The opening 106 allows air to pass in and out of the print substance container 102. In some examples, having the vent paths 104 lead to the opening 106 allows air trapped in the print substance container 102 to escape the print substance container 102, while the print substance remains in the isolation region 108 of the print substance container.

In some examples, the opening 106 is located on the cover 112 of the print substance container 102. The opening 106 can individually connect to each vent path 104-1, 104-2, 104-3, 104-4 to allow air to vent through the opening 106. In some examples, a vent path 104-3 may share a portion of the pathway with another vent path 104-4, as illustrated in FIG. 1. However, this disclosure is not so limited. For example, each vent path 104-1, 104-2, 104-3, 104-4 can have a distinct and separate pathway leading to the opening 106 of the print substance container 102. For instance, a pathway (e.g., tertiary vent path 104-3) can lead from the bottom of the print substance container 102 through a first side 111 of the print substance container 102 towards the cover 112 of the print substance container 102 leading to the opening 106. In some examples, a pathway (e.g., secondary vent path 104-2) can lead from along the top (e.g., near the cover 112) of the print substance container 102 starting near a second side 113 to the opening 106. In various examples, a pathway (e.g., vent path 104-1) can lead from the isolation region 108 to the opening 106. In addition, a pathway (e.g., vent path 104-4) can connect with another pathway (e.g., tertiary vent path 104-3) and lead to the opening 106 from the connected pathway.

FIG. 1 illustrates a print substance container 102 in a first orientation. In some examples, the first orientation is a position in which the side directly opposite the cover 112 is parallel with the ground. For instance, if print substance is in the print substance container 102 when the print substance container 102 is in the first orientation, gravity would force the print substance towards the side directly opposite the cover 112 of the print substance container 102. That is, when the print substance container is in the first orientation, the side directly opposite the cover 112 would be considered the bottom surface.

In the first orientation, when gravity pulls the print substance towards the side directly opposite the cover 112, the primary entrance 114-1 remains open and unblocked. Likewise, the primary vent path 104-1 remains open and unblocked by the print substance in the print substance container 102. As such, air is able to vent from the unblocked opening 106, which prevents print substance leakage. In the first orientation, the primary vent path 104-1 assists in keeping the opening 106 isolated from print substance. That is, although other vent paths (e.g., vent paths other than primary vent path 104-1) may be blocked, primary vent path 104-1 remains unblocked ensuring that air has a path out of the print substance container 102. Hence, the print substance is able to remain in the isolation region 108.

Having a plurality of vent paths 104 in the print substance container 102 can prevent leakage of print substance when the position of the print substance container 102 changes. That is, when the orientation of the print substance container 102 changes, air is still able to vent via one or more vent paths 104. Having a plurality of vent paths 104 ensures there is a means for air to vent from the print substance container 102 and ensures that there is no negative pressure or positive pressure in the print substance container 102. Having negative pressure or positive pressure can lead to print substance leakage. Said differently, ensuring there is an avenue for air to vent from the print substance container 102 prevents print substance leakage.

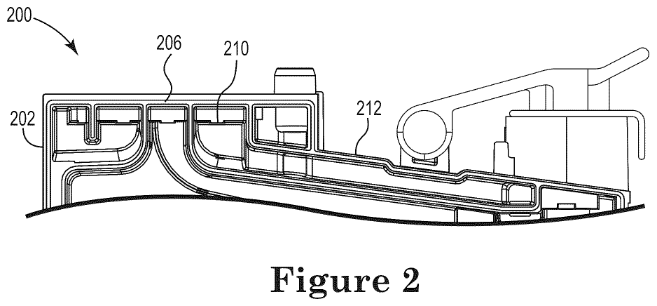

FIG. 2 illustrates an example system 200 including a print substance container 202. FIG. 2 can include analogous or similar elements as FIG. 1. For example, FIG. 2 can include an opening 206, a print substance container 202, and/or a cover 212.

In some examples, the cover 212 of the print substance container 202 can include a barrier film 210 disposed on the inside of the print substance container 202. The barrier film 210 may be disposed directly under the opening 206. In some examples, the barrier film 210 may cover the opening 206 to prevent print substance from exiting the print substance container 202. Conversely, the barrier film 210 allows air to vent from the print substance container 202. The barrier film 210 can be used to limit the materials that escape through the opening 206. For example, the barrier film 210 may prevent print substance from leaking from the print substance container 202 via the opening 206. However, conversely, the barrier film 210 may allow air to vent through the opening 206. Said differently, the barrier film 210 is not permeable to print substance but is permeable to air. The vent paths (e.g., vent paths 104-1, 104-2, 104-3, and 104-4 of FIG. 1) ensure that the barrier film 210 is isolated from the print substance when the print substance container 202 changes orientations. This ensures that the opening 206 and the barrier film 210 are not blocked by print substance when air is vented from the print substance container 202. Hence, the vent paths ensure that the print substance remain in the isolation region of the print substance container 202 and air is able to escape the print substance container 202 at all times.

In some examples, the barrier film 210 can be made from a polypropylene or polyethylene material. For instance, the barrier film 210 may be a polypropylene-based material used to block the opening 206 to prevent print substance from leaking from the opening 206 of the print substance container 202. Further, the barrier film 210 can be made from a polyethylene-based material used to limit the egress of specific materials in the print substance container 202. In some examples, the barrier film 210 may be a laminated flexible thin sealing film that is permeable to air but not permeable to print substance. Said differently, the barrier film 210 may be a vapor/oxygen barrier film that allows gases to vent from the print substance container 202. The barrier film 210 may cover the opening 206 on the inside of the print substance container 202 to allow the gases to vent from the print substance container 202 and prevent print substance from leaking through the opening 206.

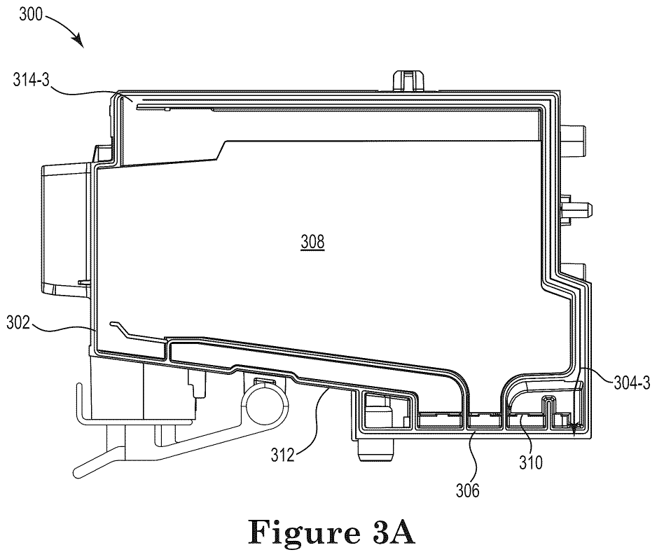

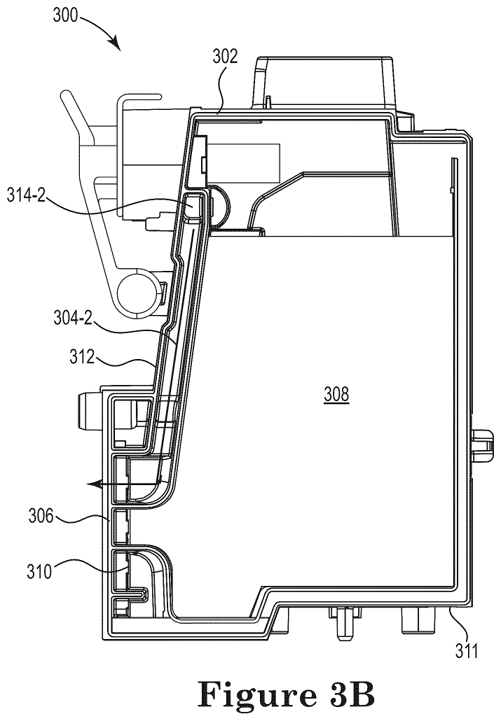

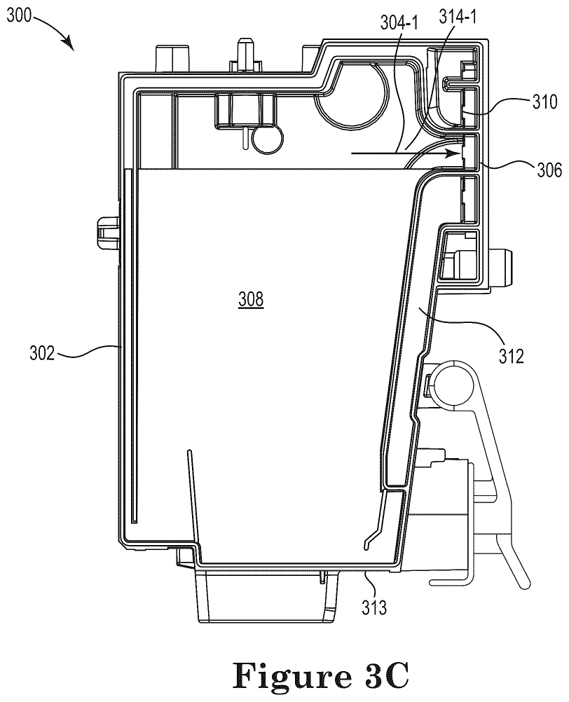

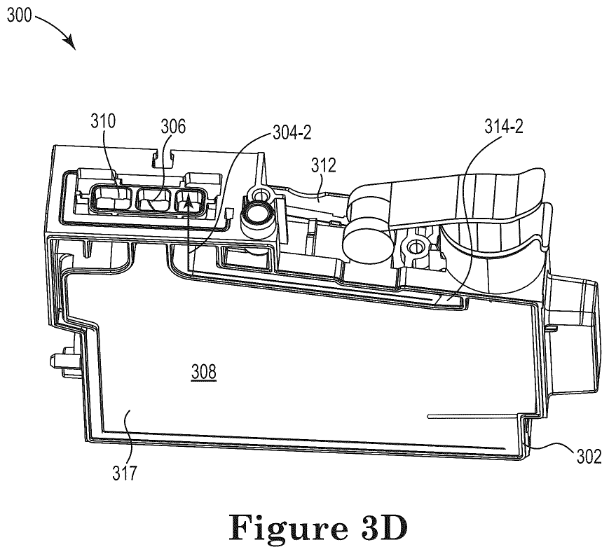

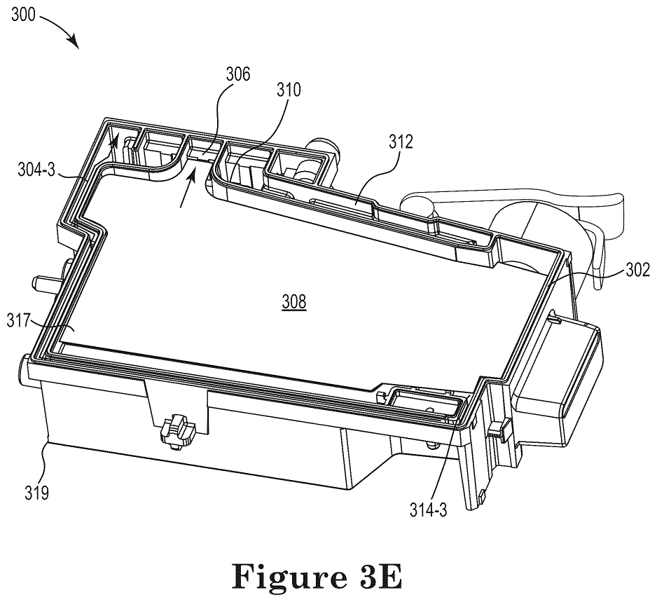

FIG. 3A illustrates an example print substance container 302 in a particular orientation. FIG. 3A can include analogous or similar elements as FIGS. 1 and 2. For example, FIG. 3A can include system 300 that includes an opening 306, a print substance container 302, a tertiary vent path 304-3, a tertiary entrance 314-3, an isolation region 308, a barrier film 310, and/or a cover 312.

FIG. 3A illustrates a print substance container 302 in a second orientation. In some examples, the second orientation is a position in which the cover 312 is parallel with the ground. For instance, if print substance is in the print substance container 302 when the print substance container 302 is in the second orientation, gravity would force the print substance towards the cover 312 of the print substance container 302. That is, when the print substance container is in the second orientation, the cover 312 would temporarily (e.g., while in the second orientation) be considered the bottom surface.

In the second orientation, when gravity pulls the print substance towards the cover 312, the tertiary entrance 314-3 remains open and unblocked. Likewise, the tertiary vent path 304-3 remains open and unblocked by the print substance in the print substance container 302. When the print substance container 302 is in the second orientation air is still able to vent out of the print substance container 302. For example, air is able to escape the isolation region 308 through tertiary entrance 314-3 and travel through the tertiary vent path 304-3 to reach the barrier film 310 and then the opening 306. Hence, the print substance in the print substance container 302 remains in the isolation region 308 and does not leak from the print substance container 302.

As described herein, a print substance container 302 including a plurality of vent paths 304 can ensure that a portion of the barrier film 310 and the opening 306 are isolated from the print substance. Isolating the print substance from a portion of the barrier film 310 and the opening 306 can ensure that air is able to vent from the print substance container 302. That is, other vent paths (e.g., vent paths other than tertiary vent path 304-3) are blocked by print substance and air cannot vent through the blocked vent paths. Moreover, in the second orientation print substance may block the pathway in the other vent paths (e.g., vent paths other than tertiary vent path 304-3). However, even with the other vent paths (e.g., vent paths other than tertiary vent path 304-3) blocked by print substance, tertiary vent path 304-3 remains unblocked in the second orientation. In addition, tertiary entrance 314-3 which is connected to the tertiary vent path 304-3 also remains unblocked in the second orientation. As such, air is able to vent from the print substance container 302.

FIG. 3B illustrates an example print substance container 302 in a particular orientation. FIG. 3B can include analogous or similar elements as FIGS. 1, 2, and 3A. For example, FIG. 3B can include a system 300 that includes an opening 306, a print substance container 302, a secondary vent path 304-2, a secondary entrance 314-2, an isolation region 308, a barrier film 310, a first side 311, and/or a cover 312.

FIG. 3B illustrates a print substance container 302 in a third orientation. In some examples, the third orientation is a position in which the first side 311 of the print substance container 302 is parallel with the ground. For instance, if print substance is in the print substance container 302 when the print substance container 302 is in the third orientation, gravity would force the print substance towards the first side 311 of the print substance container 302. That is, when the print substance container is in the third orientation, the first side 311 would temporarily (e.g., while in the third orientation) be considered the bottom surface.

In the third orientation, when gravity pulls the print substance towards the first side 311, the secondary entrance 314-2 remains open and unblocked. Likewise, the secondary vent path 304-2 remains open and unblocked by the print substance in the print substance container 302. When the print substance container 302 is in the third orientation, air is still able to vent out of the print substance container 302. For example, air is able to escape the isolation region 308 through secondary entrance 314-2 and travel through secondary vent path 304-2 to reach the barrier film 310 and then the opening 306. Maintaining at least one unblocked vent path 304 can prevent print substance from leaking out of the print substance container and ensure the print substance in the print substance container 302 to remains in the isolation region 308.

In some examples, in the third orientation, the secondary vent path 304-2 ensures that a portion of the barrier film 310 and the opening 306 are isolated from the print substance to allow air to flow through the opening 306 and barrier film 310. In the third orientation, print substance may block the pathway and the barrier film 310 connected to the other vent paths (e.g., vent paths other than secondary vent path 304-2). However, even with the other vent paths (e.g., vent paths other than secondary vent path 304-2) and the barrier film 310 connected to the other vent paths (e.g., vent paths other than secondary vent path 304-2) blocked by print substance, secondary vent path 304-2 and the portion of the barrier film 310 connected to the secondary vent path 304-2 remains unblocked in the third orientation. In addition, secondary entrance 314-2 which is connected to secondary vent path 304-2 also remains unblocked in the third orientation. As such, air is able to vent from the print substance container 302.

FIG. 3C illustrates an example print substance container 302 in a particular orientation. FIG. 3C can include analogous or similar elements as FIGS. 1, 2, 3A, and 3B. For example, FIG. 3C can include a system 300 that includes an opening 306, a print substance container 302, a primary vent path 304-1, an isolation region 308, a barrier film 310, a second side 313, and/or a cover 312.

FIG. 3C illustrates a print substance container 302 in a fourth orientation. In some examples, the fourth orientation is a position in which the second side 313 of the print substance container 302 is parallel with the ground. For instance, if print substance is in the print substance container 302 when the print substance container 302 is in the fourth orientation, gravity would force the print substance towards the second side 313 of the print substance container 302. That is, when the print substance container is in the fourth orientation, the second side 313 would temporarily (e.g., while in the fourth orientation) be considered the bottom surface.

In the fourth orientation, when gravity pulls the print substance towards the second side 313 the primary entrance 314-1 remains open and unblocked. Likewise, the primary vent path 304-1 remains open and unblocked by the print substance in the print substance container 302. When the print substance container 302 is in the fourth orientation air is still able to vent out of the print substance container 302 through primary vent path 304-1. For example, air is able to escape the isolation region 308 through primary entrance 314-1 and travel through primary vent path 304-1 to reach the barrier film 310 connected to primary vent path 304-1 and the opening 306. In some examples, when in the fourth orientation, primary vent path 304-1 assists the print container 302 in preventing print substance leakages. As such, the print substance will remain in the isolation region 308.

In some examples, in the fourth orientation, primary vent path 304-1 ensures that a portion of the barrier film 310 and the opening 306 are isolated from the print substance to allow air to flow through the opening 306 and barrier film 310. Said differently, in the fourth orientation, print substance may block the pathway and the barrier film 310 connected to the other vent paths (e.g., vent paths other than primary vent path 304-1). However, even with the other vent paths (e.g., vent paths other than primary vent path 304-1) and the barrier film 310 connected to the other vent paths (e.g., vent paths other than primary vent path 304-1) blocked by print substance, primary vent path 304-1 and connected elements remains unblocked in the fourth orientation. Specifically, the primary entrance 314-1 and barrier film 310 connected to primary vent path 304-1 are not blocked by print substance. Having the primary vent pathway 304-1 and the primary entrance 314-1, connected to the primary vent path 304-1, unblocked allows air to vent from the print substance container 302.

FIG. 3D illustrates an example print substance container 302 in a particular orientation. FIG. 3D can include analogous or similar elements as FIGS. 1, 2, 3A, 3B, and 3C. For example, FIG. 3D can include a system 300 that includes an opening 306, a print substance container 302, a secondary vent path 304-2, a secondary entrance 314-2, an isolation region 308, a barrier film 310, and/or a cover 312.

FIG. 3D illustrates a print substance container 302 in a fifth orientation. In some examples, the fifth orientation is a position in which the back side 317 of the print substance container 302 is parallel with the ground. For instance, if print substance is in the print substance container 302 when the print substance container 302 is in the fifth orientation, gravity would force the print substance towards the back side 317 of the print substance container 302. That is, when the print substance container is in the fifth orientation, the back side 317 would temporarily (e.g., while in the fifth orientation) be considered the bottom surface.

In the fifth orientation when gravity pulls the print substance towards the back side 317, the secondary entrance 314-2 remains open and unblocked. Likewise, the secondary vent path 304-2 remains open and unblocked by the print substance in the print substance container 302. When the print substance container 302 is in the fifth orientation air is still able to vent out of the print substance container 302. For example, air is able to escape the isolation region 308 through secondary entrance 314-2 and travel through secondary vent path 304-2 to reach the barrier film 310 and then the opening 306.

In some examples, in the fifth orientation, air is able to flow through the opening 306 and the barrier film 310 connected to the secondary vent path 304-2. That is, the opening 306 and the barrier film 310 connected to the secondary vent path 304-2 is not covered by print substance in the fifth orientation. As such, having the opening 306 and the barrier film 310 connected to secondary vent path 304-2 can prevent the build-up of negative pressure or positive pressure, especially when the vent paths are blocked (e.g., vent paths other than secondary vent path 304-2). For example, in the fifth orientation, print substance may block the pathway and the barrier film 310 connected to the other vent paths (e.g., vent paths other than secondary vent path 304-2). However, even with the other vent paths (e.g., vent paths other than secondary vent path 304-2) and the barrier film 310 connected to the other vent paths (e.g., vent paths other than secondary vent path 304-2) blocked by print substance, secondary vent path 304-2 remains unblocked in the fifth orientation. In addition, secondary entrance 314-2 which is connected to secondary vent path 304-2 also remains unblocked in the fifth orientation.

FIG. 3E illustrates an example print substance container 302 in a particular orientation. FIG. 3E can include analogous or similar elements as FIGS. 1, 2, 3A, 3B, 3C, and 3D. For example, FIG. 3E can include a system 300 that includes an opening 306, a print substance container 302, a tertiary vent path 304-3, an isolation region 308, a barrier film 310, and/or a cover 312.

FIG. 3E illustrates a print substance container 302 in a sixth orientation. In some examples, the sixth orientation is a position in which the front side 319 (e.g., the side directly opposite the back side 317 described in FIG. 3D) of the print substance container 302 is parallel with the ground. For instance, if print substance is in the print substance container 302 when the print substance container 302 is in the sixth orientation, gravity would force the print substance towards the front side 319 of the print substance container 302. That is, when the print substance container is in the sixth orientation, the front side 319 would temporarily (e.g., while in the sixth orientation) be considered the bottom surface.

In the sixth orientation, when gravity pulls the print substance towards the front side 319, the tertiary entrance 314-3 remains open and unblocked. Likewise, the tertiary vent path 304-3 remains open and unblocked by the print substance in the print substance container 302. When the print substance container 302 is in the sixth orientation air is still able to vent out of the print substance container 302. Examples described herein, are able to keep print substance in the isolation region 308 and prevent print substance from leaking from the print substance container 302 when the tertiary vent path 304-3, barrier film connected to the tertiary vent path 304-3, and the opening connected to the tertiary vent path 304-3 remain unblocked.

In some examples, in the sixth orientation, tertiary vent path 304-3 ensures that a portion of the barrier film 310 and the opening 306 are unobstructed by print substance to allow air to flow through the opening 306 and barrier film 310. In the sixth orientation, print substance may block the pathway and the barrier film 310 connected to the other vent paths (e.g., vent paths other than tertiary vent path 304-3). However, even with the other vent paths (e.g., vent paths other than tertiary vent path 304-3) and the barrier film 310 connected to the other vent paths (e.g., vent paths other than tertiary vent path 304-3) blocked by print substance, the tertiary vent path 304-3 remains unblocked in the sixth orientation. In addition, tertiary entrance 314-3 which is connected to tertiary vent path 304-3 also remains unblocked in the sixth orientation.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the detailed description. In addition, the proportion and the relative scale of the elements provided in the figures are intended to illustrate the examples of the detailed description and should not be taken in a limiting sense.

It should be understood that when an element is referred to as being “on,” “connected to”, or “coupled to” another element, it may be directly on, in contact, connected, or coupled with the other element or intervening elements may be present.

It should be understood that the descriptions of various examples may not be drawn to scale and thus, the descriptions may have a different size and/or configuration other than as shown therein.

What is claimed:

1. An apparatus comprising:
an opening to allow air to pass in and out of the apparatus;
a barrier film covering the opening to prevent print substance from exiting the apparatus;
an isolation region to house a print substance; and
a plurality of vent paths to allow air to vent from the opening when the apparatus is in different orientations.

2. The apparatus of claim 1, further comprising three vent paths of the plurality of vent paths to confine print substance into the isolation region.

3. The apparatus of claim 2, wherein the barrier film allows air to vent from the apparatus.

4. The apparatus of claim 3, wherein the plurality of vent paths comprises a primary vent path connecting to the isolation region to prevent print substance leakage in a first orientation and a fourth orientation.

5. The apparatus of claim 3, wherein the plurality of vent paths comprises a secondary vent path to prevent print substance leakage in a third orientation and a fifth orientation.

6. The apparatus of claim 3, wherein the plurality of vent paths comprises a tertiary vent path to prevent print substance leakage in a second orientation and a sixth orientation.

7. A system comprising:
an enclosure to house print substance;
an opening on a cover of the enclosure;
a barrier film covering the opening to prevent print substance from leaking from the enclosure; and
a plurality of vent paths, wherein each vent path connects to the opening.

8. The system of claim 7, wherein the vent paths prevent the print substance from blocking the barrier film when an orientation of the enclosure shifts.

9. The system of claim 8, wherein the enclosure shifts into six different orientations.

10. The system of claim 7, wherein the barrier film is a vapor and air barrier film.

11. The system of claim 7, further comprising an isolation region to house the print substance.

12. A print substance container comprising:
an isolation region to house print substance;
an opening to vent air from an inside of the print substance container; and
a plurality of vent paths, wherein the plurality of vent paths prevent the print substance from leaking from the print substance container when an orientation of the print substance container shifts by allowing air to vent from the print substance container.

13. The print substance container of claim 12, wherein each vent path leads to the opening.

14. The print substance container of claim 12, further comprising a barrier film to cover the opening.

15. The print substance container of claim 14, wherein the barrier film is a laminated flexible thin sealing film.
